(19) United States
(12) Patent Application Publication
(10) Pub. No.: US 2026/0066202 A1
(43) Pub. Date: Mar. 5, 2026

(54) SWITCH MECHANISM AND POWER-ON METHOD

(71) Applicant: NEXT INNOVATION INC., Minato-ku, Tokyo (JP)

(72) Inventor: Hiroshi Michiwaki, Minato-ku, Tokyo (JP)

(21) Appl. No.: 19/105,310

(22) PCT Filed: Aug. 23, 2023
(86) PCT No.: PCT/JP2023/030398

§ 371 Date: Feb. 20, 2025

(30) Foreign Application Priority Data
Aug. 25, 2022 (JP) 2022-133999

(51) Int. Cl. H01H 36/00

(52) U.S. Cl. CPC H01H 36/00

(57) ABSTRACT

A switch mechanism includes: a magnetic switch that accepts a first operation and a second operation, the first operation enabling a first contact member and a second contact member to transition from a contact state to a non-contact state or from the non-contact state to the contact state by an external magnetic field, a second operation enabling the first contact member and the second contact member to transition from the contact state to the non-contact state or from the non-contact state to the contact state at least once or more by the external magnetic field; and a controller that operates in response to an operation on the magnetic switch. The controller drives a power receiving device when the second operation performed on the magnetic sensor is accepted.

### CROSS-REFERENCE TO RELATED APPLICATIONS

This application is a national phase entry under 35 U.S.C. § 371 of International Patent Application PCT/JP2023/030398, filed Aug. 23, 2023, designating the United States of America and published as International Patent Publication WO 2024/043290 A1 on Feb. 29, 2024, which claims the benefit under Article 8 of the Patent Cooperation Treaty of Japanese Patent Application Serial No. 2022-133999, filed Aug. 25, 2022.

### TECHNICAL FIELD

The present disclosure relates to a switch mechanism provided in various electrical/electronic circuits and the like, and a power-on method of the switch mechanism.

### BACKGROUND

Conventionally, there have been switches that are configured to switch the on/off state of power through the contact and separation between a fixed-side terminal (hereinafter referred to as “contact terminal”) and a movable-side contact piece (hereinafter referred to as “movable contact piece”). These so-called contact switches typically expose their switching mechanisms to the outside.

However, such so-called contact switches often malfunction due to factors like excessive vibration, resulting in unintended on/off states. Furthermore, when the switching mechanism is exposed externally, unintended contact may cause the switch to open or close. Additionally, the weather resistance of the switch contact points may lead to problems such as poor contact or unintended conduction due to water leakage, immersion, corrosion, or the like.

To address these problems, the use of reed switches as non-contact switches has been considered. However, reed switches are turned on or off by a magnetic force, and operates when a magnet is brought close thereto. Therefore, the reed switches are unintentionally turned on or off due to some influences of external magnetic fields, potentially leading to malfunctions of terminals equipped with the reed switches.

The present disclosure, which has been made through extensive research in view of the above problems, has an object to provide a means that can be disposed without exposing a mechanism externally, and that, with a simplified structure, enables reliable prevention of occurrence of malfunctions, while driving power-receiving devices via non-contact operation using external magnetic fields.

### BRIEF SUMMARY

The switch mechanism of the present disclosure includes: a magnetic switch configured to accept a first operation and a second operation, the first operation enabling a first contact member and a second contact member to transition from a contact state to a non-contact state or from the non-contact state to the contact state by an external magnetic field, the second operation enabling the first and second contact members to transition from the contact state to the non-contact state or from the non-contact state to the contact state at least once or more by the external magnetic field; and a controller that operates in response to an operation performed on the magnetic switch. The controller drives a power-receiving device, as a power supply destination, when the second operation performed on the magnetic sensor is accepted.

In the switch mechanism of the present disclosure, the magnetic switch, upon accepting the first operation, closes a circuit between the controller and a power supply unit, and the controller is activated by power supplied from the power supply unit.

In the switch mechanism of the present disclosure, the external magnetic field used for the first operation may be generated by a permanent magnet and/or an electromagnet.

In the switch mechanism of the present disclosure, the controller includes a logic circuit.

In the switch mechanism of the present disclosure, the controller further includes a computing device equipped with the logic circuit.

In the switch mechanism of the present disclosure, the controller may include an electric circuit.

In the switch mechanism of the present disclosure, the controller may include one or more of a vacuum tube, a relay, a transistor, and/or an FET.

In the switch mechanism of the present disclosure, the external magnetic field used for the second operation may also be generated by a permanent magnet and/or an electromagnet.

In the switch mechanism of the present disclosure, the external magnetic field used for the second operation changes temporally and/or spatially.

In the switch mechanism of the present disclosure, the external magnetic field used for the second operation generates a temporally and/or spatially varying signal.

In the switch mechanism of the present disclosure, the controller includes a signal judgment unit that pre-stores a signal code and determines whether the temporally and/or spatially varying signal generated by the external magnetic field used for the second operation matches the signal code.

In the switch mechanism of the present disclosure, if the signal judgment unit determines that the signal matches the signal code, the controller drives or enables the power-receiving device to drive.

A switch mechanism of the present disclosure includes: a controller including a switching element; and a switch connected to a control input terminal of the switching element and configured to detect a change in a physical phenomenon. The switch operates by detecting the change in the physical phenomenon around the switch, and the controller can be activated by a voltage being applied to the control input terminal in response to the operation of the switch.

In the switch mechanism of the present disclosure, the switch may detect magnetic force, light, heat, sound, wind, and/or vibration.

In the switch mechanism of the present disclosure, the controller may include a logic circuit.

In the switch mechanism of the present disclosure, the controller may include a computing device equipped with the logic circuit.

In the switch mechanism of the present disclosure, the controller may include an electric circuit.

A power-on method of the present disclosure includes: an activation step of activating a controller by a switch unit, upon occurrence of a specific physical phenomenon; an acquisition step of acquiring, as a code, an input to the switch unit, which is performed in response to further occurrence of a physical phenomenon; a determination step of determining, by the controller, whether the code acquired in the acquisition step matches a pre-set signal code; and a power supply step of controlling, by the controller, power supply to a power-receiving device when the code matches the signal code.

The present disclosure provides a switch mechanism that can be disposed without exposing the mechanism externally, and with a simplified structure, enables reliable prevention of occurrence of malfunctions, while driving a power-receiving device via operation of a magnetic switch using external magnetic fields.

### BRIEF DESCRIPTION OF THE DRAWINGS

FIG. 1 is a block diagram of a processing terminal equipped with a switch mechanism according to the present embodiment.

FIG. 2 is a flowchart illustrating control processes associated with power-on operations.

### DETAILED DESCRIPTION

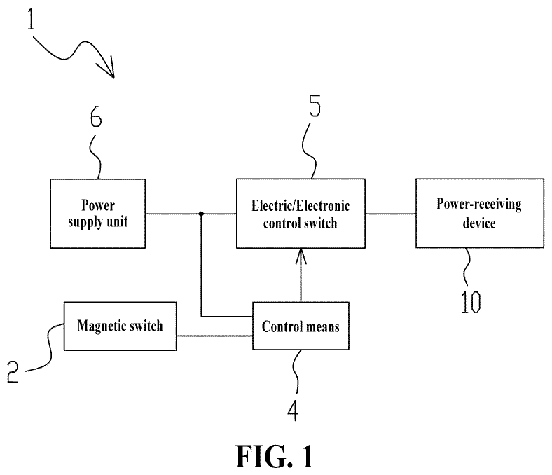

Below, embodiments of a processing terminal as a switch mechanism of the present disclosure are described with reference to the drawings. FIG. 1 illustrates a block diagram showing a system configuration example of a processing terminal 1 according to the present embodiment. The processing terminal 1 includes a magnetic switch 2, a control means (controller) 4, an electric/electronic control switch 5, a power supply unit 6, a power-receiving device 10, and the like. The switch mechanism of the present disclosure includes the magnetic switch 2, the control means 4, the electric/electronic control switch 5, and the like.

The magnetic switch 2 operates in response to the application of a magnetic field and performs the opening and closing of the circuit between the control means 4 and the power supply unit 6. The magnetic switch 2 may have any mechanism as long as it operates by an external magnetic field. Specifically, the magnetic switch 2 may transition between two states, i.e., a contact state and a non-contact state of a first contact member and a second contact member that have magnetism. These first and second contact members are preferably housed within a protective casing to prevent malfunctions due to an input from outside, or the like, though this is not mandatory. For example, a sealed glass container may be used as the protective casing, but a sealed glass cylinder does not necessarily have to be used. Materials other than the glass cylinder, for example, containers made of materials such as quartz, ceramics, resin, or metal can also be used. The design may even omit the container entirely, and may include only the two contact members.

When using a metal container for the protective casing of the first and second contact members, the metal may be non-magnetic, ferromagnetic, or diamagnetic. If a ferromagnetic material is used, measures such as ensuring sufficient distance are required to prevent the residual magnetism generated in the metal container by the application of the external magnetic field from adversely affecting on the magnetic switch 2.

The two contact members (the first and second contact members) of the magnetic switch 2 may both move in response to the application of a magnetic field, to transition between the contact and non-contact states. Alternatively, one of the first and second contact members may remain fixed, with only the other moving in response to the application of the magnetic field to transition between the contact and non-contact states.

The magnetic switch 2 may also be configured such that the contact members are in the contact state before the application of the magnetic field and separated from each other upon application of the magnetic field, to transition to the non-contact state. Conversely, in the magnetic switch 2, the contact members may be in the non-contact state before the application of the magnetic field and may transition to the contact state upon application of the magnetic field.

The control means 4 controls the opening and closing of the circuit between itself and the power supply unit 6 and makes power-supply judgments for the system of the power-receiving device 10 based on the timing of turning on and off of the magnetic switch 2.

For this purpose, the control means 4 may include computing devices such as a microcontroller and/or a microcomputer, and/or a microprocessor, and may cause the computing devices to perform logical operations. Additionally, the control means 4 may include a memory, etc., for pre-storing signal codes used in power-supply judgments.

The control means 4 may also be configured with switching elements such as vacuum tube, FETs, relays, transistors, or other electronic control switches. The control means 4 can maintain the power-on state between the control means 4 and the power supply unit 6 through these switching elements.

The control input terminal of the switching element in the control means 4 may be directly or indirectly connected to the magnetic switch 2. The control input terminal corresponds to components such as the gate in FETs, the base in transistors, and the grid in vacuum tubes.

When the magnetic switch 2 is connected to the control input terminal, the application of voltage to the control input terminal of the switching element upon operation of the magnetic switch 2 (e.g., when the first and second contact members come into contact with each other) enables conduction, to thereby connect the circuit between the control means 4 and the power supply unit 6.

The control means 4 may also be implemented using electric circuits. In other words, power supply control can be realized using electric circuits combining physical elements and wiring.

The control means 4 may include multiple switching elements, such as two FETs. For example, the first FET may close the circuit between the control means 4 and the power supply unit 6, allowing power to be supplied only to the control means 4 when the magnetic switch 2 is closed. The second FET may close the circuit for power supply to the control means 4 after the control means 4 have been activated. That is, the second FET closes the circuit between the control means 4 and the power supply unit 6, to ensure stable power supply even after the magnetic switch 2 is opened. In other words, once the control means 4 is electrically connected to the power supply unit 6, it can continue receiving power supplied from the power supply unit 6, regardless of whether the magnetic switch 2 is open or closed.

The electric/electronic control switch 5 operates as a switch (e.g., relay circuit, semiconductor switch, and the like) controlled electrically and/or electronically, and performs the opening and closing of the circuit between the power supply unit 6 and the power-receiving device 10.

The power supply unit 6 is a power source device composed of an external power source, batteries (a primary battery, a secondary battery, etc.), or other components, and supplies power to respective parts of the processing terminal 1.

The power-receiving device 10 includes a main system such as a system for computation of the processing terminal 1. The power-receiving device 10 includes, as hardware for causing the processing terminal 1 to operate, components such as a CPU (Central Processing Unit), a memory, a storage, a communication I/F, a bus, etc. The power-receiving device 10 is not limited to the components as described above and may include various electrically driven devices in addition to electrical lines, electronic circuits, and the like.

The CPU controls the overall system and performs computations. The memory can include a ROM (Read-Only Memory) and a volatile storage device such as a RAM (Random Access Memory).

The storage may include non-volatile storage devices such as SSDs (Solid State Drives) or HDDs (Hard Disk Drives), for example. The storage stores control programs by the CPU, other programs, and data such as results of CPU processing.

The communication interface (I/F) is used to connect to networks. The bus links the CPU, a storage section, and the communication I/F, to thereby enable information exchange. The power-receiving device 10 may also include an input/output interface (I/F), in addition to the above-mentioned components.

The switch mechanism of the present disclosure used in processing terminal 1 includes: the magnetic switch 2 that accepts the first operation for causing the first and second contact members to transition from the contact state to the non-contact state or from the non-contact state to the contact state by the external magnetic field, and accepts the second operation for causing the first and second contact members to transition from the contact state to the non-contact state or from the non-contact state to the contact state at least once or more by the external magnetic field; and the control means 4 that performs operation in response to the operation performed on the magnetic switch 2. When the magnetic switch 2 accepts the first operation, the control means 4 is activated, and when the magnetic switch 2 accepts the second operation, the control means 4 drives the power-receiving device 10.

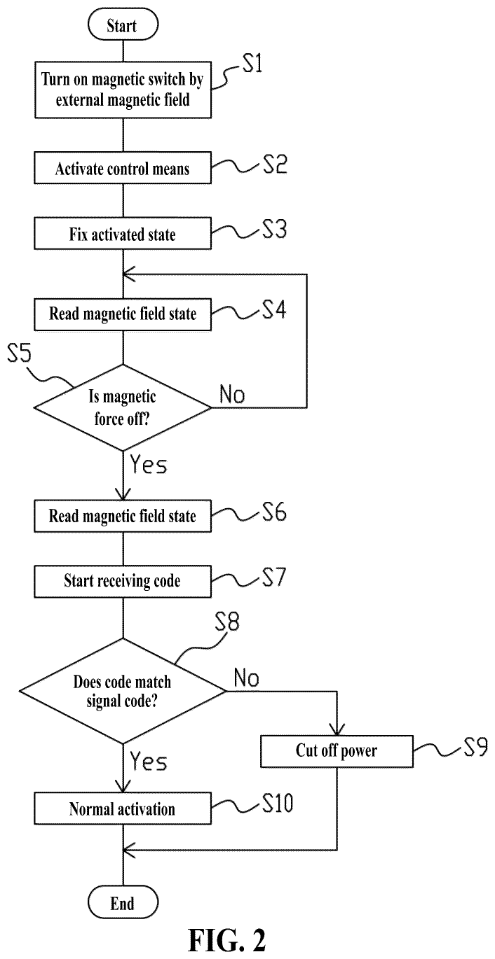

FIG. 2 illustrates a flowchart for the control processes associated with the power-on operations. Here, as a power-on means by the first operation for powering on the processing terminal 1, the power-on is performed by application of an external magnetic field. The external magnetic field used for the power-on by the first operation can be generated by a permanent magnet and/or an electromagnet. In other words, the processing terminal 1 is powered on by bringing the power-on means including the permanent magnet and/or the electromagnet close to a predetermined part of the processing terminal 1 (in the vicinity of the magnetic switch 2, for example). In addition, the first and second operations may be performed by the same power-on means, but the operations are performed by different power-on means in the present embodiment.

For the second operation, a power-on means for the second operation in which an external magnetic field that changes temporally and/or spatially is used. For example, with the power-on means for the second operation, the external magnetic field state can be alternately switched between a state where the external magnetic field is applied to the magnetic switch 2 and a state where the application of the external magnetic field is stopped. Such a power-on means for the second operation causes a signal for power-on to be transmitted to the processing terminal 1. The signal transmitted has a predetermined pattern, and if the signal pattern corresponds to a pre-defined signal code, the entire system of the processing terminal 1 is powered on.

Needless to say, also in the first operation, the power-on means using an external magnetic field that changes temporally and/or spatially can also be used. Also in this case, signals are transmitted by alternately switching the external magnetic field state between the state where the external magnetic field is applied to the magnetic switch 2 and the state where application of the external magnetic field is stopped. However, it is preferable that the transmitted signal pattern differs from the signal pattern used in the second operation.

The user of the processing terminal 1 brings the power-on means close to the magnetic switch 2 of the processing terminal 1. This causes an external magnetic field to be applied, to thereby turn on the magnetic switch 2 (Step S1). Power is then fed from the power supply unit 6 to the control means 4, to activate the control means 4 (Step S2). Specifically, components such as FETs, relays, transistors, or other electronic control switches in the control means 4 are used to close the circuit between the control means 4 and the power supply unit 6, allowing power to be supplied from the power supply unit 6 solely to the control means 4 and enabling the control means 4 to be operable.

The control means 4 fixes its power-on state (Step S3). In other words, the control means 4 uses the second FET, to close the circuit between itself and the power supply unit 6. As a result, even if the magnetic switch 2 turns off during the control process for powering on, the activated state of the control means 4 is maintained.

The control means 4, after having been activated, monitors the magnetic switch 2, to read the external magnetic field state (referred to as the “magnetic field state”) (Step S4) and determine whether the magnetic force has been turned off (Step S5).

After bringing the power-on means close to the magnetic switch 2 to move it away from the magnetic switch 2, the user brings the second power-on means close to the magnetic switch 2. The processing terminal 1 recognizes the proximity of the first power-on means in Step S1 and determines whether the power-on means, the proximity of which has been recognized, is moved away, in Step S5.

While the power-on means remains close, the control means 4 determines that the magnetic force is “on” (Step S5, No) and performs the processes in Steps S4-S5 again to read the magnetic field state, to determine whether the magnetic force has been turned “off.”

When the power-on means is moved away, the control means 4 determines that the magnetic force is “off” (Step S5, Yes) and starts receiving codes transmitted through the magnetic switch 2 (Step S6). Specifically, when the operator brings the second power-on means close to the magnetic switch 2, to thereby cause the signals generated by alternating the application and cessation of the external magnetic field to be transmitted to the control means 4. Thus, the control means 4 receives the signals transmitted via the magnetic switch 2 (Step S7).

The control means 4 recognizes the code based on the received signals and determines whether the code matches the signal code stored in the memory (Step S8). At this stage, the control means 4 functions as a signal judgment unit to determine whether the received code matches the signal code.

If determining that the signal does not match the signal code (Step S8, No), the control means 4 cuts off the power supply to the control means 4 (Step S9), to end the power-on process.

On the other hand, if determining that the received code matches the signal code (Step S8, Yes), the control means 4 performs control so that power is fed to the power-receiving device 10. Specifically, the control means 4 closes the electric/electronic control switch 5, to cause the power to be supplied from the power supply unit 6 to the power-receiving device 10.

As a result, the processing terminal 1 is activated normally (step S10) with power supplied to each part of the terminal, including the power-receiving device 10, and thereby the power-receiving device 10 (system) is driven or is brought into a drivable state. Thus, the power-on process ends and various kinds of processing can be executed by normal control processes.

As described above, the operation of the magnetic switch enables the power-on process of the processing terminal. By combining the first operation and the second operation, malfunctions such as unintended power supply by the switch mechanism to the power-receiving device caused by unintended external magnetic fields generated around the magnetic switch can be prevented. Specifically, since the second operation requires transmitting signals corresponding to the predefined signal code, by configuring the signal code itself with detailed or unique patterns, occurrence of the malfunctions due to influences of unintended external magnetic field can be prevented.

Additionally, since the switch mechanism can be disposed without exposing a part or all of its components externally, occurrence of the malfunctions caused by vibrations or an external contact can be reliably prevented. Furthermore, the weather resistance, durability, and the like of the mechanism can be enhanced to protect against degradation or alteration caused by wind, rain, sunlight, or temperature changes.

In the above-described embodiment, the switch mechanism has been explained as accepting, via the magnetic switch, the first operation and the second operation utilizing the external magnetic fields. However, the switch mechanism is not limited to this configuration. The switch mechanism may also be configured to perform the first operation or the second operation based on physical phenomena other than magnetism.

Examples of such physical phenomena other than magnetism include light, heat, sound, wind, vibration, or the like. In such cases, a switch unit other than a magnetic switch may be employed to appropriately detect the respective physical phenomena. For instance, when using light, a receiving switch equipped with a light-receiving element can receive on/off patterns of light, as signals. When using heat, a temperature detection switch, such as one utilizing bimetals or shape memory alloys, can detect patterns of temperature rise and fall, for example, as signals. When using sound, a sound switch (or sound sensor) equipped with a transducer or a microphone can receive patterns of the presence or absence of sound production as signals. When using wind, a wind speed switch can detect airflows, and on/off states based on changes in wind speed. When using vibration, a vibration sensing switch that can detect vibration and is turned on/off by the presence or absence of vibration or changes can be used. When using heat, the Seebeck effect can be utilized to generate electric power, which may then be used to activate the control means.

Furthermore, the opening and closing of the circuit between the power supply unit 6 and the control means 4 can also be controlled by external command signals from the power-receiving device or other external sources. By cutting off the power supplied to the control means 4, the power consumption associated with the switch mechanism of the present disclosure can be minimized.

### REFERENCE NUMERALS LIST

1: Processing terminal, 2: Magnetic switch, 4: Control means, 5: Electric/electronic control switch, 6: Power supply unit, 10: Power-receiving device.

1. A switch mechanism comprising:
a magnetic switch that accepts a first operation and a second operation, the first operation enabling a first contact member and a second contact member to transition from a contact state to a non-contact state, or from the non-contact state to the contact state, by an external magnetic field, the second operation enabling the first contact member and the second contact member to transition from the contact state to the non-contact state or from the non-contact state to the contact state at least once or more by the external magnetic field; and
a controller that operates in response to an operation performed on the magnetic switch, wherein the controller drives a power-receiving device, when the second operation performed on the magnetic switch is accepted.

2. The switch mechanism of claim 1, wherein the magnetic switch, upon accepting the first operation, closes a circuit between the controller and a power supply unit, and the controller is activated by power supplied from the power supply unit.

3. The switch mechanism of claim 1, wherein the external magnetic field used for the first operation is generated by a permanent magnet and/or an electromagnet.

4. The switch mechanism of claim 1, wherein the controller includes a logic circuit.

5. The switch mechanism of claim 4, wherein the controller includes a computing device equipped with the logic circuit.

6. The switch mechanism of claim 1, wherein the controller includes an electric circuit.

7. The switch mechanism of claim 1, wherein the controller includes one or more of a vacuum tube, a relay, a transistor, and/or a field effect transistor (FET).

8. The switch mechanism claim 1, wherein the external magnetic field used for the second operation is generated by a permanent magnet and/or an electromagnet.

9. The switch mechanism of claim 1, wherein the external magnetic field used for the second operation changes temporally and/or spatially.

10. The switch mechanism of claim 1, wherein the external magnetic field used for the second operation generates a temporally and/or spatially varying signal.

11. The switch mechanism of claim 10, wherein the controller includes a signal judgment unit that pre-stores a signal code and determines whether the temporally and/or spatially varying signal generated by the external magnetic field used for the second operation matches the stored signal code.

12. The switch mechanism of claim 11, wherein the controller drives or enables the power-receiving device to drive when the signal judgment unit determines that the signal matches the signal code.

13. A switch mechanism comprising:
a controller including a switching element, and
a switch connected to a control input terminal of the switching element and configured to detect a change in a physical phenomenon, wherein:
the switch operates by detecting the change in the physical phenomenon around the switch, and
the controller can be activated by applying a voltage being to the control input terminal in response to an operation of the switch.

14. The switch mechanism of claim 13, wherein the switch can detect magnetic force, light, heat, sound, wind, and/or vibration.

15. The switch mechanism of claim 13, wherein the controller includes a logic circuit.

16. The switch mechanism of claim 15, wherein the controller includes a computing device equipped with the logic circuit.

17. The switch mechanism of claim 13, wherein the controller includes an electric circuit.

18. A power-on method comprising:
activating a controller, by a switch unit, upon occurrence of a specific physical phenomenon;
acquiring, as a code, an input to the switch unit, which is performed in response to further occurrence of a physical phenomenon;
determining, by the controller, whether the code acquired in the acquisition step matches a pre-set signal code; and
controlling, by the controller, power supply to a power-receiving device when the code matches the signal code.
